(19) United States
(12) Patent Application Publication
(10) Pub. No.: US 2016/0292622 A1
(43) Pub. Date: Oct. 6, 2016

(54) SYSTEMS AND METHODS FOR INDEXING RESOURCES TO A PROJECT SCHEDULE

(71) Applicant: NOTEVAULT, INC., San Diego, CA (US)

(72) Inventors: Peter Joel Lasensky, Del Mar, CA (US); Sean Spencer Spicer, SR., San Diego, CA (US)

(21) Appl. No.: 15/088,030

(22) Filed: Mar. 31, 2016

Related U.S. Application Data
(60) Provisional application No. 62/141,465, filed on Apr. 1, 2015.

(51) Int. Cl. G06Q 10/06

(52) U.S. Cl. CPC G06Q 10/063118

(57) ABSTRACT

A system and method for capturing and/or retrieving activity information in association with corresponding tasks and/or projects are disclosed. Activity information regarding an activity may be associated with a task ID identifying a task with which the activity is associated. Each of the task IDs may be associated with one or more corresponding projects, indicating the task identified by the task ID is associated with the project. This may facilitate users to obtain activity information and index the obtained activity information to corresponding task(s) and/or project(s). This may facilitate report generation that may acquire project information by obtaining activity information indexed to the project.

### FIELD OF THE INVENTION

The invention relates to systems and methods for indexing resources to a project schedule including online information processing of mobility generated data.

### BACKGROUND

In project management, a project is typically defined as a temporary endeavor (e.g., operations) to produce a unique product, service or result within a defined period. The temporary nature of a project stands in contrast with the underlying operations, which tend to be repetitive or semi-repetitive within the business scope of the entity or entities performing the project. As an illustration, in a construction project (e.g., building a recreational pool), contractors provide daily construction services (e.g., excavating, grading, gunite work, tile work, etc.) that are repetitive or routine within the scope of their construction business. In practice, management of a project and a business typically require development of distinct technical skills and strategies. Projects are typically managed in real-time or near real-time with finer precision as compared to how businesses are managed. This presents a problem in that operational information critical to project management is often not captured because of the repetitive nature of the underlying operations. For example, during the construction job, operational information such as the specific type of cement used for the gunite work, the quantity of labor that worked on-site at a specific point in time, equipment used, running time of the equipment and/or any other operational information is often not captured and thus cannot be tracked when such becomes an issue. Accordingly, there is a need to provide a way to integrate information pertaining to operations into project management seamlessly.

### SUMMARY

One aspect of the disclosure may relate to indexing resources to a project schedule. In accordance with various implementations of the disclosure, this includes enabling a client device to obtain information regarding an activity from a user. The user may include an employer (e.g., a property owner that hired a contractor to build a pool on the property), a contractor, a sub-contractor, a supervisor, and/or any other entities related to a project. The activity information may include an activity ID identifying the activity, a task ID associated with the activity, description of the activity, location of the activity, one or more participants of the activity, information regarding resources used or engaged during the activity—e.g., material used or consumed, equipment used- and/or any other information related to the activity. The task ID(s) included in the activity information received from the user may be used to “link” the activity to a project comprising the task(s) identified by the task ID(s). In some examples, the task ID(s) may be predetermined on the client device as being associated with the project. The activity information may be transmitted to a server over a communications network for storage and further processing.

At the server, electronic storage, e.g., database, may be configured to store the activity information received from client devices in association with corresponding projects. For example, the database may be configured with relational metadata indicating a given project ID is associated with one or more task IDs, each of which is associated with one or more activity IDs. Based on such relational metadata, project information may be organized to comprise blocks of task information, each of which is organized to comprise blocks of activity information. In this way, a given project may be managed (e.g., tracked or reported or analyzed) by indexing activity information to the corresponding project.

Another aspect of the disclosure may relate to facilitating generating a report regarding a project. Electronic storage of a server may be configured to store information regarding an individual project in association with information regarding one or more tasks corresponding to the project. The electronic storage may be further configured to store information regarding an individual task in association with information regarding one or more activities corresponding to the task. The information regarding an individual activity may include one or more of an activity ID, task IDs, resource information indicating one or more resources used in connection with the activity, participants in the activity, and/or any other activity information. The server may be configured to retrieve from the electronic storage resource information using a project ID. This may be achieved by the server by generating a query to retrieve relevant activity information that is associated with the project ID via corresponding task ID(s), extracting the resource information from the relevant activity information, processing the extracted resource information, generating a report, transmitting the report to the client device for presentation to the user, and/or any other operations.

Another aspect of the disclosure may relate to resource accounting related to a project. A first user (e.g., an employer) may be enabled to provide information regarding an activity associated with the project via the client device associated with the first user. The activity information provided by the first user may include one or more of an activity ID, task ID(s), project ID, date information, resource information such as material, equipment, labor, and/or any other information related to the activity as observed by the first user. In a similar fashion, a second user (e.g., a contractor) may be enabled to provide similar information regarding the same activity as observed by the second user via a client device associated with the second user. The activity information provided by the first and second users may be received by the server. The server may be configured to compare the activity information from the first and second users based on the activity ID, determine if there is inconsistency between the activity information provided by the first and second users, generate notifications to the client device of the first user and/or second user for verification or removal of the inconsistencies, storing activity information only after the consistencies are removed by the first and/or second users, and/or any other operations.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to facilitate indexing of resources to project schedule, in accordance with one or more implementations.

FIG. 2 illustrates an exemplary implementation of a client device shown in FIG. 1.

FIG. 3 illustrates an exemplary implementation of activity information obtained from a user by the client device shown in FIG. 1.

FIG. 4 illustrates exemplary implementations of various interfaces presented on a client device to enable a user create an activity associated with a task in a project.

FIG. 5 illustrates an exemplary implementation of the collector/server shown in FIG. 1.

FIG. 6 illustrates an exemplary implementation of the project management component included in the server shown in FIG. 5.

FIG. 7 illustrates exemplary implementations of various project, task, and activity information stored by the collector/server shown in FIG. 1.

FIG. 8 illustrates an exemplary implementation of a project report generated by the collector/server shown in FIG. 1.

FIG. 9 illustrates a system configured to facilitate indexing of resources to project schedule, in accordance with one or more implementations.

FIG. 10 illustrates a method for storing activity information in association with a task and/or a project, in accordance with one or more implementations.

FIG. 11 illustrates a method for storing activity information in association with a task and/or a project, in accordance with one or more implementations.

FIG. 12 illustrates a method for generating a report regarding a project, in accordance with one or more implementations.

### DETAILED DESCRIPTION

In the following description, numerous specific details are set forth such as examples of specific components, devices, methods, etc., in order to provide a thorough understanding of implementations of the present invention. It will be apparent to one skilled in the art, however, that these specific details need not be employed to practice implementations of the present invention. In other instances, well-known materials or methods have not been described in detail in order to avoid unnecessarily obscuring implementations of the present invention. The term “coupled” as used herein, may mean directly coupled or indirectly coupled through one or more intervening components.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

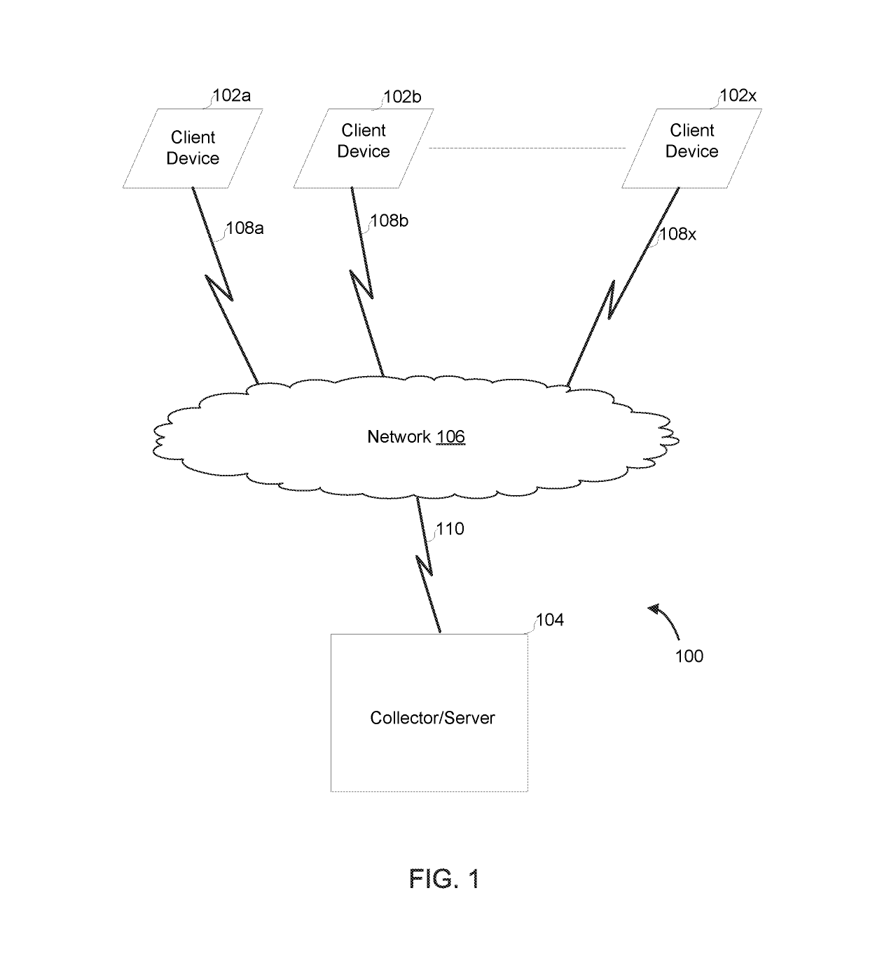

FIG. 1 illustrates a system 100 configured to facilitate indexing of resources to project schedule, in accordance with one or more implementations. As shown, system 100 may include one or more client devices 102 for communicating data with a collector/server 104 over network 106 via respective links 108. The links 108 may include any wired and/or wireless link. Likewise, as shown, the collector/server 104 may be connected to the network 106 via a link 110, which may include any wired and/or wireless link. Network 106 may include a cellular or wireless network operating according to any voice and/or data communication standard. Network 106 may include any variety of non-wireless transmission media including, without limitation, fiber optic cable, twisted-pair wire, or coaxial cable. Network 106 may also include a combination of connected sub-networks; e.g., a cellular network connected to a Public Switched Telephone Network (PSTN).

Client devices 102 may include any type of device capable of collecting and transmitting data. Examples of a given client device 102 may include a smart phone, a tablet, a hand-held device, a wearable device (e.g., a smart watch), a laptop, a Netbook, a desktop computer, a game console, a set-top box, a printer, and/or any other type of client device. The data collected by the client devices 102 may include voice or other audio content, text or other symbols, images or other graphics, videos, gestures, indications (e.g., a finger tap at a certain location of the screen of a smartphone), numbers, any/or any other type of data. In some implementations, the client devices 102 may be configured to transmit the collected data via messages. A message is a collection of data formatted to anyone of a variety of message formats. A message may be associated with corresponding metadata (either included in the message or transmitted separately in connection with the metadata). Metadata may include identifiers (ID's), header, addresses, footers, and/or any other additional information related to the message or its transmission. In some implementations, client devices 102 transmit data in the device's wireless cellular protocol, such as CDMA direct sequence BPSK or QPSK. In some implementations, client devices 102 may be Internet-enabled communication devices configured to transmit message and data files in the transmission control protocol (TCP) of the Internet protocol (IP) suite.

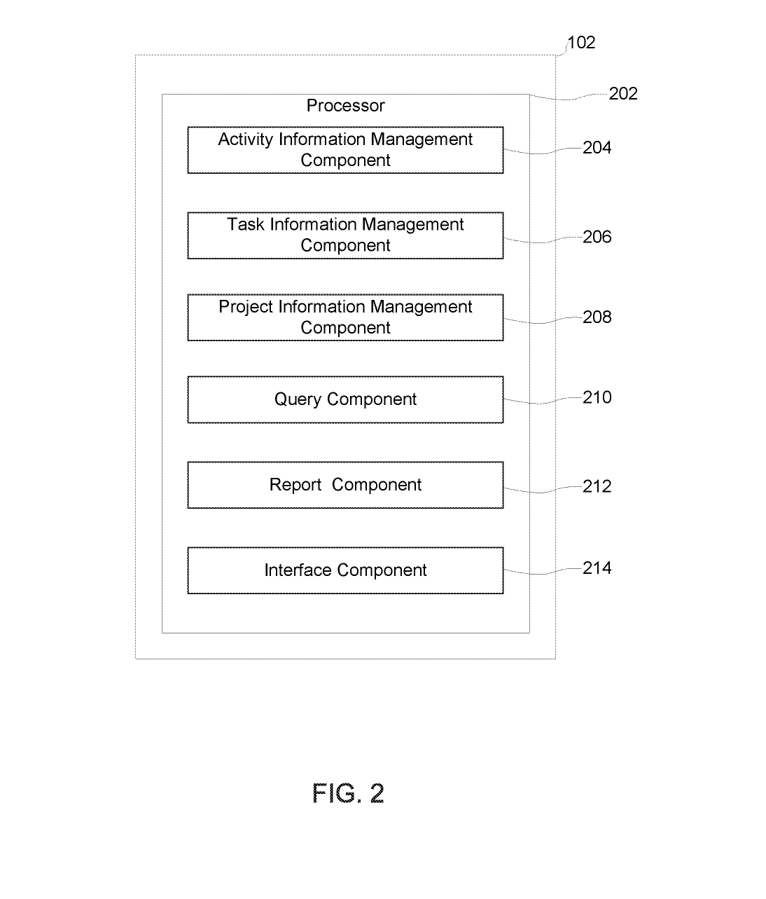

Referring now to FIG. 2, it illustrates an exemplary implementation of a client device 102 shown in FIG. 1. As shown, client device 102 may include a processor 202 configured to execute computer programs, and/or any other components (e.g., one or more of memory storage, an internal bus, graphics processing unit, power unit, I/O subsystem, various peripherals or embedded devices such as camera, keyboard, one or more sensors, and/or any other components). As shown, client device 102 may include one or more of an activity information management component 204, a task information management component 206, a project information management component 208, a query component 210, a report component 212, an interface component 214, and/or any other components.

The activity information management component 204 may be configured to manage records of activity information obtained from a user associated with the activity via an interface provided by the client device 102. The individual records of activity information managed by the activity information management component 204 may correspond to individual activities observed and/or participated by the user. Managing such activity information by the activity information management component 204 may involve one or more of storing activity information obtained from the user in association with an activity ID that identifies the corresponding activity reported by the user; modifying a portion or all of particular activity information upon a user request; deleting particular activity information; indexing activity information in accordance with corresponding task IDs as indicated by the user; and/or any other operations.

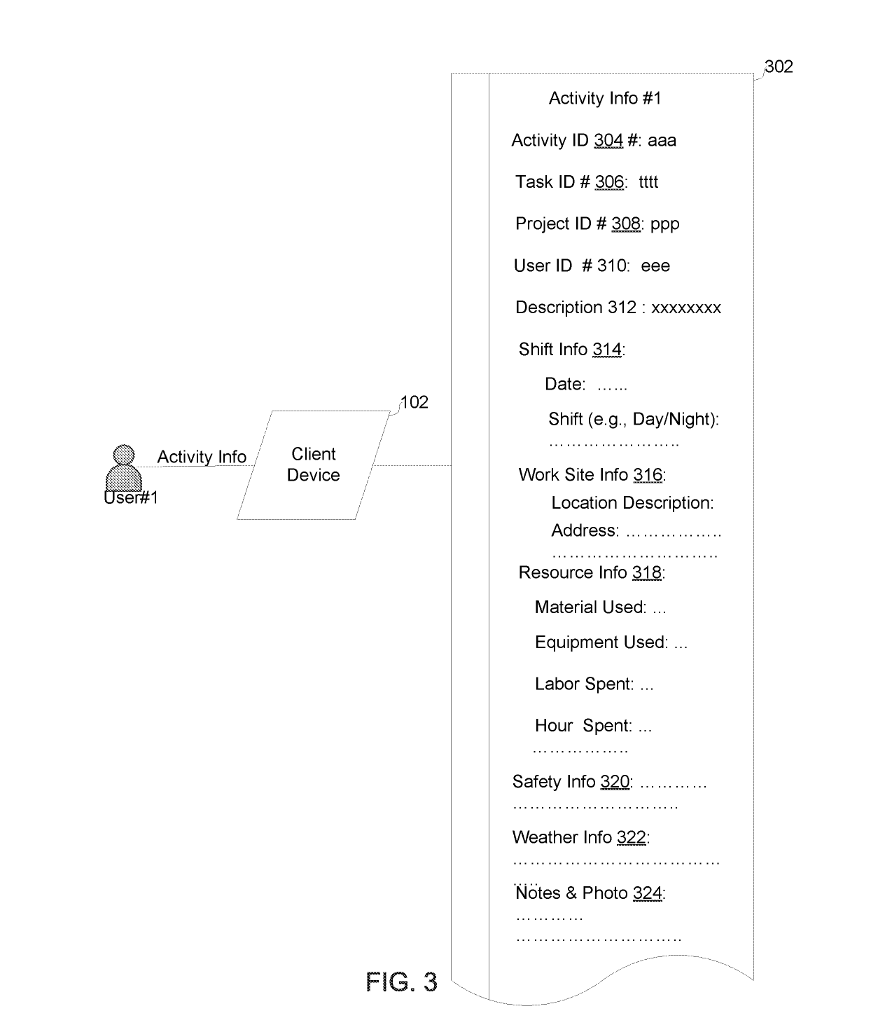

FIG. 3 illustrates an exemplary implementation of activity information 302 obtained from a user by the client device 102 shown in FIG. 1. As shown, activity information 302 may include one or more of an activity identifier (ID) 304 identifying an underlying activity; a task identifier (ID) 306 identifying what the underlying activity is associated with; a user ID 310 identifying the user, i.e., user #1 in this example; description 312 about the underlying activity, which may include one or more of textual, voice, video and/or any other type of description; shift information 314 such as the date of the underlying activity, specific shift (e.g., day or night shift as shown) during which the underlying activity took place and/or any other shift information, such as one or more of overtime hours, time and a half, or double time; work site information 316 such as one or more of location description about the location where the underlying activity took place, address of the location and/or any other worksite information; resource information 318 indicating one or more resources used in connection with the activity—as shown in this example, which may include one or more of material used during the underlying activity, equipment used during the underlying activity, number of laborers (e.g., three sub-contractors) who participated in the underlying activity, number of hours spent for the underlying activity (e.g., 15 hours total or 3 hours/per person, etc.); safety information 320 indicating one or more safety situations, issues, concerns or any other events related to safety (e.g., personnel or long term) observed for the activity; weather information 322 indicating weather conditions during the activity; notes and photo information 324 including one or more of photos, video clips and/or voice clips uploaded by the user, notes taken by the user, and/or any other notes and photo information 324; and/or any other activity information 302. Some of the information as shown being included in the activity information 302 may be provided by the user through the client device 102. For example, the user may provide one or more of activity description 312, safety information 320, weather information 322, and/or note information 324 via a textual input means provided by the client device 102 (e.g., virtual keyboard on a smart phone, or a physical keyboard on a laptop). However, this is not necessarily the only case. Some of the information included in activity information 302 may be generated by client device 102 intelligently based on preexisting records. For example, as will be described below, task ID 306 may be inserted into the activity information based on activity/task association managed by task information management component 206. It should be understood the various information shown as being included in activity information 302 shown in FIG. 3 is merely illustrative. In some other examples, more or less information than that shown in FIG. 3 may be included in activity information 302.

Returning to FIG. 2, task information management component 206 may be configured to manage information records regarding one or more tasks, which may be associated with activity information managed by activity information management component 204. Managing the record of task information by the task information management component 206 may involve associating the record of task information with one or more records of the activity information obtained by activity information management component 204 based on task ID 306. In implementations, this may involve populating the record of task information with the activity information that includes task ID matching of the task ID.

The individual records of task information managed by task information management component 206 may correspond to individual tasks and may be retrieved from collector/server 104. For example, a record of task information may be retrieved (e.g., downloaded) from collector/server 104, which may include a task ID predetermined by the provider(s) of system 100. In some implementations, the user associated with client device 102 may be enabled to create and/or modify a record of task information managed by task information management component 206. For example, an interface may be provided on client device 102 to enable the user to create a new record of task information for a corresponding task. In that example, a task ID may be automatically created by task information management component 206 for the new record of task information.

A given record of task information managed by task information management component 206 may include information indicating one or more projects with which the given record of task information is associated. In some implementations, this association may be predetermined by the provider(s) of system 100 and retrieved from collector/server 104. For example, the provider(s) of system 100 may determine the underlying task indicated by the given record of task information is associated with a corresponding project. In that example, the given record of task information retrieved from server 102 may contain a project ID 308 (see FIG. 3) indicating a project the underlying task is associated with as determined by the provider(s) of system 100. In some implementations, the user may be enabled to specify a task is associated with a project. For example, the user may be enabled by an interface provided on client device 102 to specify a newly created task is associated with a project. In that example, upon the creation of the record of task information, project ID 308 of the project specified by the user may be populated into the record of task information.

Project information management component 208 may be configured to manage information records regarding one or more projects, which may be associated with task information managed by task information management component 206. The individual task information managed by task information management component 206 may correspond to individual tasks and may be retrieved from collector/server 104. For example, a record of project information may be retrieved (e.g., downloaded) from collector/server 104, which may include project ID 308 predetermined by the provider(s) of system 100.

Managing the record of project information by project information management component 208 may involve associating the record of project information with one or more records of the task information managed by task information management component 206 based on project ID 308. In implementations, this may involve populating the record of project information with the task information that includes project ID 308 matching that included in the record of project information.

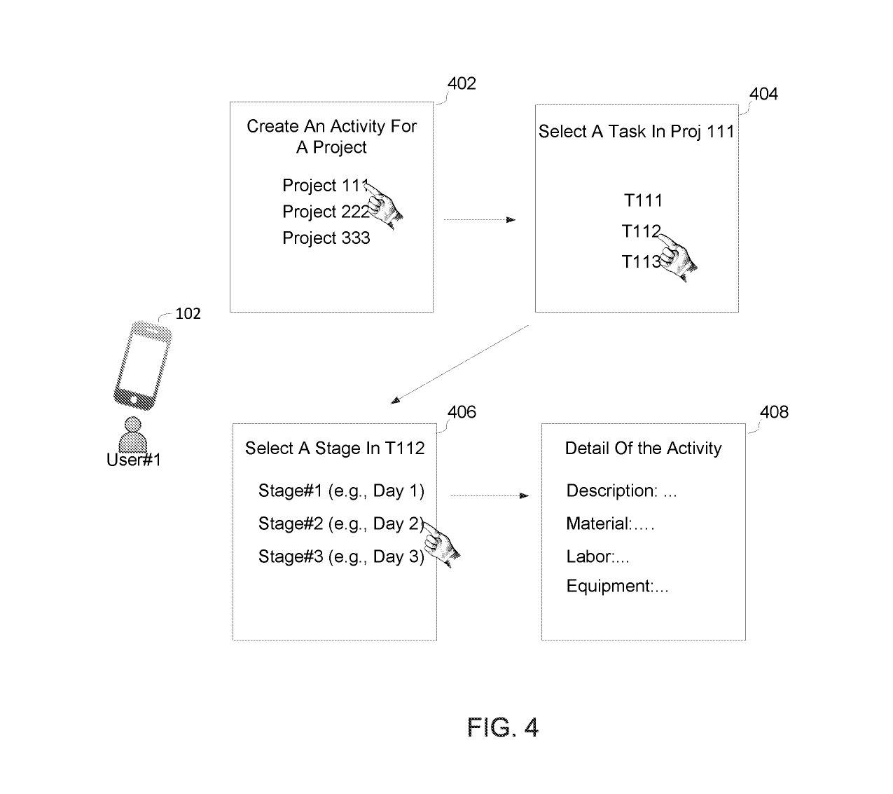

FIG. 4 illustrates exemplary implementations of various interfaces presented on a client device 102 to enable a user create an activity associated with a task in a project. It will be described with reference to FIG. 1. As shown, an interface 402 may be provided on client device 102 to enable a user (e.g., user #1) to select a project when creating a new activity. The projects displayed on interface 402 may each be associated with unique project ID 308 as described. In some implementations, the projects displayed on interface 402 may be managed by project information management component 208 as described herein.

As shown, after the user has selected a project, an interface may be provided on client device 102 to enable the user to select a task with which the activity is associated. The tasks displayed on interface 404 may each be associated with a unique task ID as described. As also described, each task displayed on interface 404 is associated with the project selected by the user via interface 402, i.e., project 111 as shown in this example. In some implementations, the tasks displayed on interface 404 may be managed by task information management component 208 as described herein.

After the user has selected a task, an interface 406 may be provided on client device 102 to enable the user to select a stage for which the activity is to be created. The stages displayed on interface 406 may be managed by project information management component 208 as part of the record of task information regarding the task—e.g., task 112 as shown. For example, the stages of a task may be predetermined by the provider(s) of system 100 and may be retrieved from server 102 by project information management component 208. In some other implementations, the stages of the tasks may be determined and inserted into the record of task information by the user.

As also shown, after the user has selected a stage of the task for which the activity is to be created, an interface 408 may be provided on client device 102 to enable the user to provide various information regarding the activity. The information provided by the user via interface 408 may be captured into the record of activity information 302 as shown in FIG. 3.

Returning to FIG. 2, query component 210 may be configured to manage queries to enable the user to obtain information regarding the activities. The queries managed by query component 210 may be created by the provider(s) of system 100 and/or may be created by the user. Examples of queries managed by query component 210 may include one or more of querying resources used by activities, production reports (e.g., labor hours/material quantities) by shifts, production trends, time entries by contractors and/or sub-contractors, and/or any other queries.

By way of illustration, a query may be managed by query component 210 to enable the user to obtain information regarding resources used in a project. Such a query may be implemented by querying all resources used by the activities that are associated tasks in the project. As another example, a query may be managed by query component 210 to enable the user to obtain information regarding task completion during a period of time specified by the user. Such a query may be implemented by querying all task activities completed during the period of time, querying goals for the tasks associated with those activities, and generating completion percentage reports for the tasks by comparing the activity completion with the task goals (e.g., the records of activities 1 and 2 in task #2 indicate 3 out of 5 goals of task #2 have been completed). Still as another example, a query may be managed by query component 210 to enable the user to generate a production trend based on the activities completed so far. Other examples of queries managed by query component 210 are contemplated.

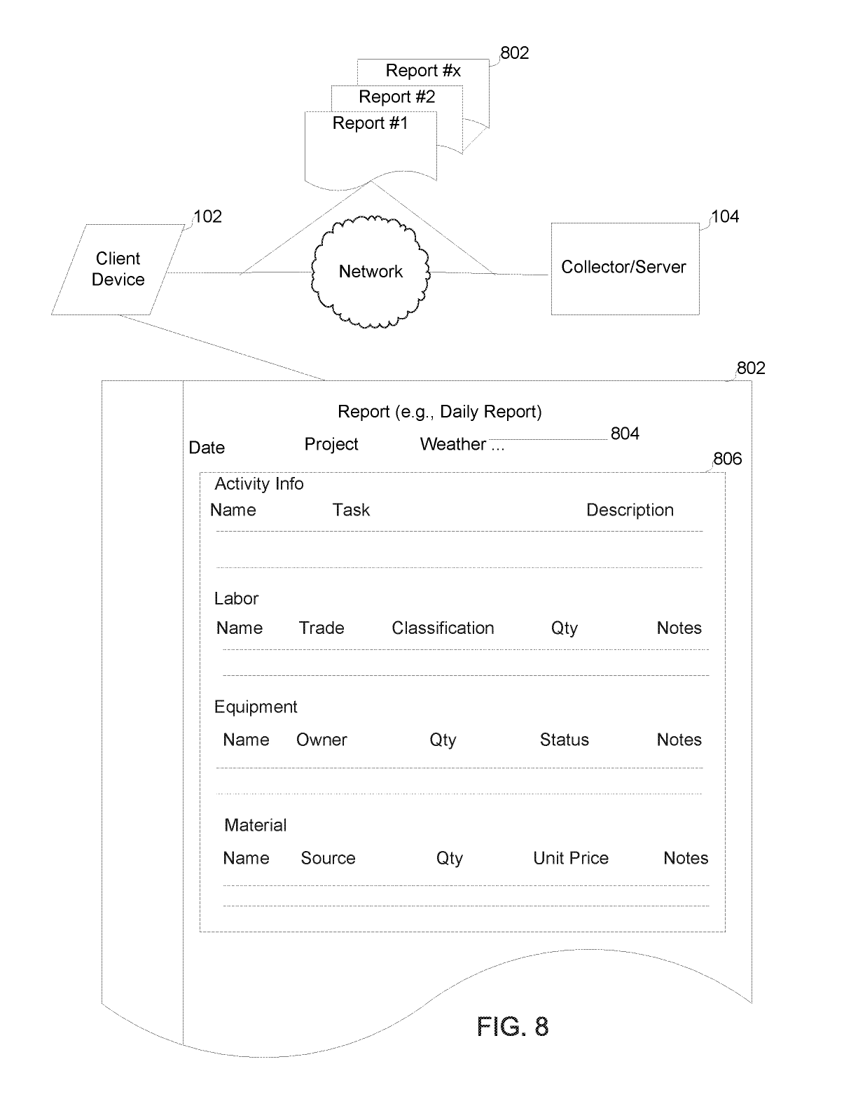

Report component 212 may be configured to provide a report for presentation to the user. The reports generated by report component 212 may contain information regarding one or more of the activities, tasks, projects and/or any other information. In some implementations, report component 212 may be configured to provide reports based on the results of the queries managed by query component 210. An example of the reports that may be provided by report component 212 is described and illustrated in FIG. 8.

Interface component 214 may be configured to implement interfaces on client device 102 to receive user inputs and convey information to the user. Implementing interfaces by interface component 214 may involve determining specific layouts for the interface, the size of the interface, one or more controls in the interface to receive inputs from the user, menus presented in the interface, and/or any other constructs related to providing interfaces on client device 102. The interfaces implemented on client device 102 may include the interfaces described herein; for example, one or more of interfaces 402, 404, 406, 408 and/or any other interfaces.

Processor(s) 202 is configured to provide information processing capabilities in client device 102. As such, processor 202 may include one or more of a digital processor, an analog processor, a digital circuit designed to process information, an analog circuit designed to process information, a state machine, and/or other mechanisms for electronically processing information. Although processor 202 is shown in FIG. 2 as a single entity, this is for illustrative purposes only. In some implementations, processor 202 may include a plurality of processing units. These processing units may be physically located within the same device, or processor 202 may represent processing functionality of a plurality of devices operating in coordination. Processor 202 may be configured to execute one or more of modules 204, 206, 208, 210, 212, and/or 214. Processor 202 may be configured to execute one or more of modules 204, 206, 208, 210, 212, and/or 214 by one or more of software; hardware; firmware; some combination of software, hardware, and/or firmware; and/or other mechanisms for configuring processing capabilities on processor 202.

It should be appreciated that although modules 204, 206, 208, 210, 212, and/or 214 are illustrated in FIG. 2 as being co-located within a single processing unit, in implementations in which processor 202 includes multiple processing units, one or more of modules 204, 206, 208, 210, 212, and/or 214 may be located remotely from the other modules. The description of the functionality provided by the different modules 204, 206, 208, 210, 212, and/or 214 described below is for illustrative purposes, and is not intended to be limiting, as any of modules 204, 206, 208, 210, 212, and/or 214 may provide more or less functionality than is described. For example, one or more of modules 204, 206, 208, 210, 212, and/or 214 may be eliminated, and some or all of its functionality may be provided by other ones of one or more of modules 204, 206, 208, 210, 212, and/or 214. As another example, processor 202 may be configured to execute one or more additional modules that may perform some or all of the functionality attributed below to one or more of modules 204, 206, 208, 210, 212, and/or 214.

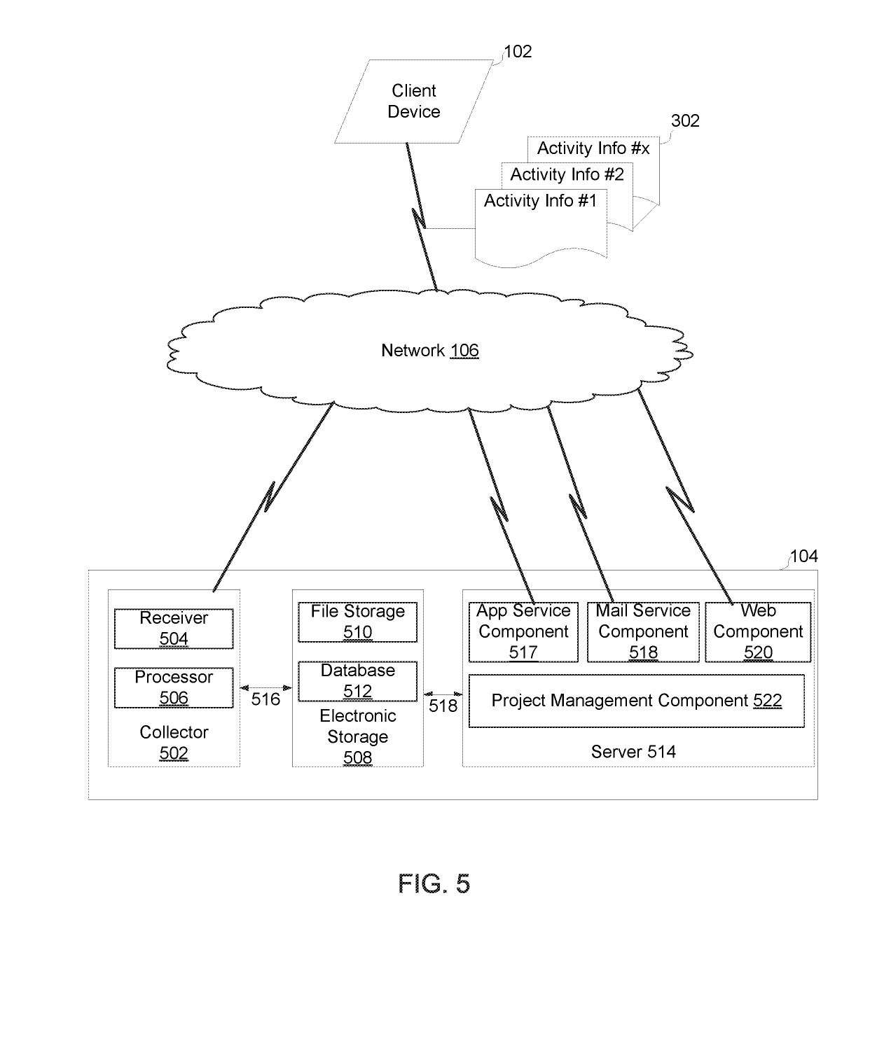

Having generally described client device 102, attention is now directed to FIG. 5. FIG. 5 illustrates an exemplary implementation of the collector/server 104 shown in FIG. 1. It will be described with reference to FIGS. 1-4. As shown, the collector/server 104 may communicate activity information 302 with client device 102. For example, collector/server system 104 may receive activity information 302 from client device 102 and/or transmit activity information 302 to client device 102 for presentation as described herein. In this example, collector/server 104 includes collector 502, electronic storage 508, and server 514. Collector 502 can include one or more receivers 504, each of which has a unique address that is addressable by client device 102. Receiver 504 may be configured to receive a message and associated metadata, preferably in the receiver's native format from client device 102. Collector 502 may also include processor 506 that can reformat a received message and associated metadata into a format meaningful to the memory structures in electronic storage 508, which may include one or more of a file storage 510, a database 512 and/or any other components. Collector 502 may be configured to route the message and metadata to electronic storage over a suitable connection 516 between collector 502 and electronic storage 508. Electronic storage 508 may include one or more of a WAN, LAN, PAN, bus, and/or any other connection medium or communications platforms and protocols.

In an alternative implementation, collector 502 can be interfaced with an electronic device such as a router that can be capable of receiving and routing multiple unique addresses. Thus, collector 502 can comprise an interface, such as an IP interface configured to connect collector 502 with such an electronic gateway. In such an implementation, collector 502 can still comprise a receiver portion, such as receiver 504, configured to receive messages and associated metadata routed from the electronic gateway, although not necessarily in the format native to the particular type of client device 102 used. Accordingly, collector 502 can utilize processor 506 to reformat the received messages and associated metadata into a format meaningful to the memory structures in electronic storage 508, and route the message metadata to electronic storage 508 over connection 516. Database 512 may be configured to accept message metadata from collector 502 and parse the received metadata into its components, including one or both of the content of the sender's message and the unique communication device identifier.

Electronic storage 508 may comprise electronic storage media that electronically stores information. The electronic storage media of electronic storage 508 may include one or both of system storage that is provided integrally (i.e., substantially non-removable) with collector/server 104 and/or removable storage that is removably connectable to collector/server 104 via, for example, a port (e.g., a USB port, a firewire port, etc.) or a drive (e.g., a disk drive, etc.). Electronic storage 508 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 508 may include one or more virtual storage resources (e.g., one or more of cloud storage, a virtual private network, and/or other virtual storage resources). Electronic storage 508 may store one ore more of software algorithms, information received from collector/server 104, and/or information received from client device 102. As shown in this example, electronic storage 508 may include one or more of file storage 510 configured to store electronic files, database 512 configured to store information, and/or any other components.

As shown, collector/server 104 may include a server 514. The server 514 may include one or more of a web component 520, a mail service component 518, an app service component 517, a project management component 522, and/or any other components. While functionally distinct, web component 520, mail service component 518, and app service component 517 may be a single functionally integrated server. Further, web component 520 may be embodied as a servlet program resident on a host server platform. Server 514 may be connected with electronic storage 508 via server network connection 518, which may include one or more of a WAN, LAN, PAN, bus and/or any other type of communication link. It will be understood by those of ordinary skill in the art that server 514 may include one or more of a processor, memory, and/or software sufficient to carry out its functions. Server 514 may further include a farm of servers distributed among separate server devices or spread geographically via connections. Server 514 may receive requests from client device 102, and respond to requests through one or more of web component 520, mail service component 518, and/or app service component 517. Mail service component 518 may be configured to transmit electronic notifications, via email or short message service (SMS) protocol, to a requester or recipient of a message. The notification can include a hypertext link to web component 520. Web component 520 may receive a copy of a requested message from electronic storage 508, and serve up the copy in a webpage to the requester or recipient. The webpage can be formatted according to a markup language, such as extensible markup language (XML) or hypertext markup language (HTML), and downloaded via any transport technique to a browser or other rendering program.

Server 514 may include a project management component 522. The project management component 522 may be configured to manage project information regarding projects. This may involve storing project information and/or retrieving project information upon requests. Project management component 522 may be configured to communicate with electronic storage 508 to store and retrieve project information. Project management component 522 may be configured to communicate with client device 102 to receive or transmit project information from or to client device 102. For example, project management component 522 may be configured to receive activity information 302 from client device 102 and populate project information stored in the database 512 with the received activity information based on task ID(s) included in the received activity information. As another example, project management component 522 may be configured to retrieve project information stored in electronic storage 508 upon a request from client device 102 and transmit the retrieved project information to the client device 102.

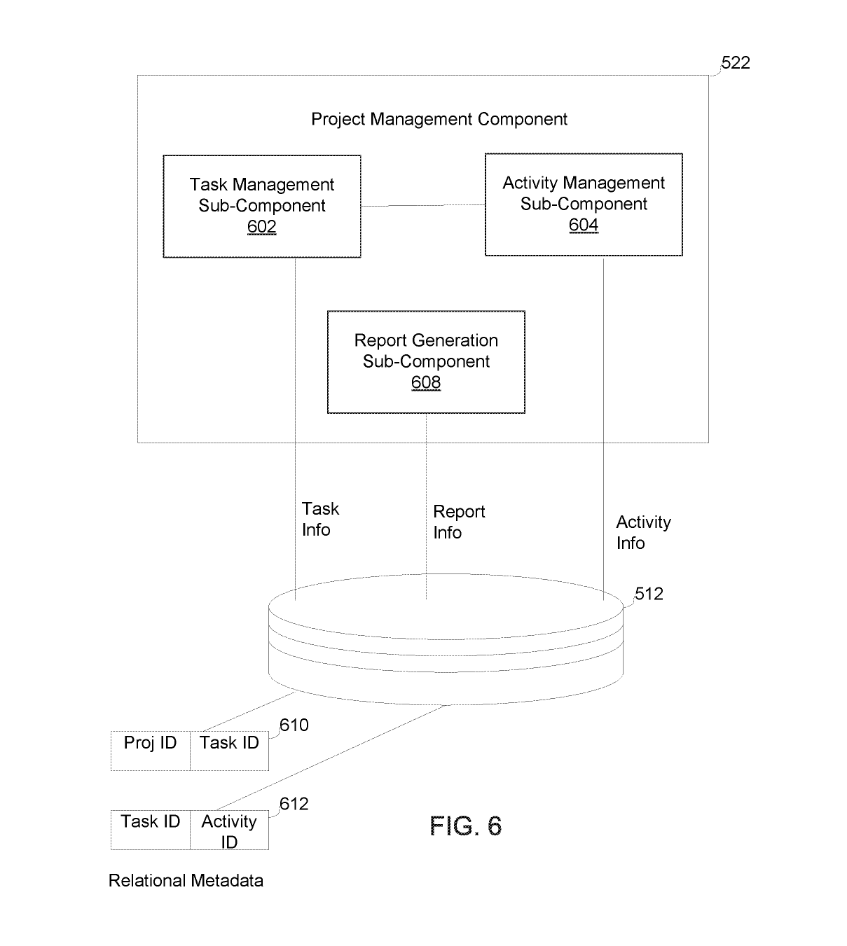

FIG. 6 illustrates an exemplary implementation of the project management component 522 included in the server 514 shown in FIG. 5. As shown, project management component 522 may include one or more of a task management sub-component 602, an activity management sub-component 604, a report generation sub-component 608, and/or any other components. Task management sub-component 602 may be configured to manage task information for the tasks corresponding to projects. As shown, task management sub-component 602 may store and/or retrieve task information to and from database 512. As also shown, task management sub-component 602 may be configured to store task information in accordance with a metadata relationship between projects and tasks as shown by the relationship 610, which specifies particular project ID 308 may be associated with a particular task ID.

Activity management sub-component 604 may be configured to manage activity information for the activities associated with the tasks managed by task management sub-component 602. As shown, activity management sub-component 604 may store and/or retrieve activity information to and/or from database 512. As also shown, activity management sub-component 604 may be configured to store activity information 302 in accordance with a metadata relationship between projects and tasks as shown by the relationship 612, which specifies a particular task ID may be associated with a particular activity ID.

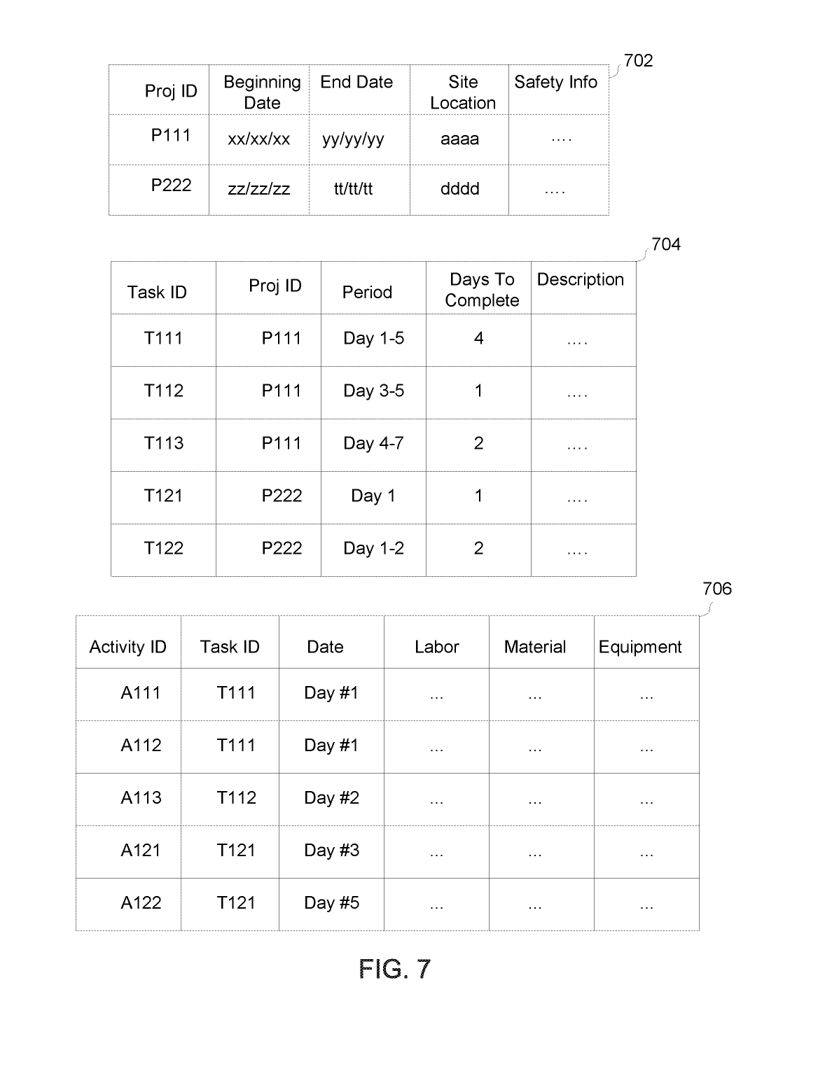

FIG. 7 illustrates exemplary implementations of various project, task, and activity information stored by the collector/server 104 shown in FIG. 1. As shown, a table 702 may be established to track various information regarding tasks scheduled in projects. As also shown, table 702 may be established to store project information regarding projects. As shown, table 702 may be indexed by the project ID column, which may be used to store identifications that identify underlying projects. As also shown, other columns of table 702 may be used to capture various information regarding the projects, such as one or more of the beginning and end date of a project, location of the project, safety information of the project, personnel information about the project, and/or any other project information.

A table 704 may be established to store task information regarding tasks scheduled in the projects stored in table 702. As shown, table 704 may be indexed by a task ID column, which may be used to store identifications that identify underlying tasks. As shown, each task ID in table 704 is associated with corresponding project ID 308. As also shown, other columns of table 704 may be used to capture various information regarding the tasks, such as one or more of a period of the task (e.g., as estimated by the provider(s) of system 100), days left to complete the task, description of the task, and/or any other task information. In this example, as illustrated, three tasks, T111, T112, and T113, are associated with the project P111. This indicates those three tasks are scheduled in project P111.

A table 706 may be established to store activity information regarding activities associated with the tasks stored in table 704. As shown, table 706 may be indexed by an activity ID column, which may be used to store identifications that identify underlying activities. As shown, each activity ID in table 706 is associated with a corresponding task ID. As also shown, other columns of table 706 may be used to capture various information regarding the activities, such as one or more of a date of the activity (e.g., as provided by the user via client device 102), labor, material, equipment used in connection with the activity, and/or any other activity information. In this example, as illustrated, two activities (A111 and A112) are associated with task T111. This indicates information regarding those two activities is provided by the user (or users) as being indexed to task T111.

Returning to FIG. 6, the report generation sub-component 608 may be configured to generate reports upon requests. The report generation sub-component 608 may receive requests from client device 102. For example, client device 102 may transmit a query via query component 210 to collector/server 104 to generate a report about resources that have been used for a project. As another example, client device 102 may transmit a request via report component 212 to collector/server 104 instructing collector/server 104 to generate a daily project report. Upon receiving such requests, collector/server 104 may generate requested reports via report generation sub-component 608 included in server 514.

FIG. 8 illustrates an exemplary implementation of a project report generated by the collector/server 104 shown in FIG. 1. As shown, a report 802 may be generated by collector/server 104 and transmitted to client device 102 for presentation on client device 102 to the user. FIG. 8 illustrates that a daily project report may be generated and presented to the user in this manner. As shown, report 802 may contain a section 804 describing the project that is the subject of report 802. The information in section 804 may be from table 702 shown in FIG. 7. Report 802 may contain a section 806 describing one or more activities indexed to scheduled corresponding tasks in the project. The information shown in section 806 may be from table 706 and is presented in report 802 by virtue of being associated with common task IDs between the activities and the project. As shown, section 806 may include sub-sections describing one or more of labor spent, equipment used, material consumed in connection with the activity, and/or and any other activity information.

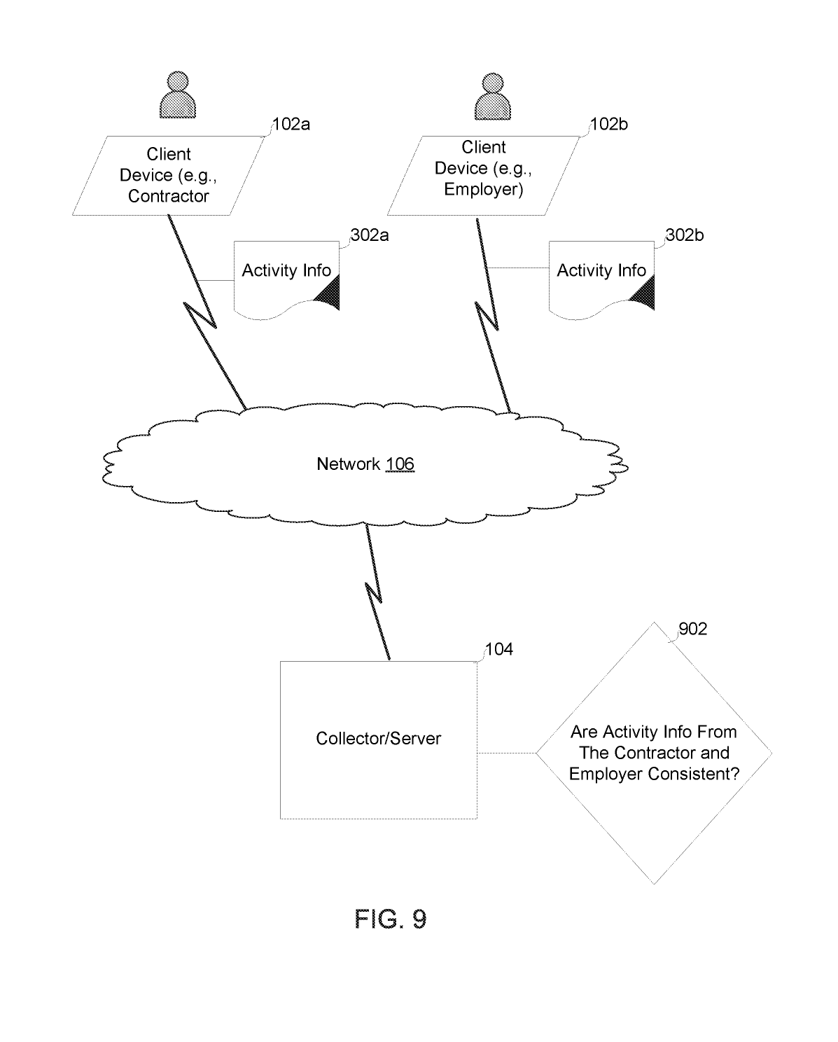

FIG. 9 illustrates a system configured to facilitate indexing of resources to project schedule, in accordance with one or more implementations. It will be described with reference to FIGS. 1-3. As shown in this example, in accordance with one implementation of the disclosure, a client device 102a may be configured to enable a user such as a contractor to provide activity information as described herein. A client device 102b may be configured to enable a user such as an employer (e.g., owner of a property on which the project is taking place) to provide activity information as described herein. The activity information provided by client devices 102a and 102b may be for the same activity—i.e., the contractor and employer may be enabled to provide information regarding the same activity. At collector/server 104, activity information for the same activity from the client devices 102a and 102b may be received. Collector/server 104, in this implementation, may be configured to determine if the activity information from the two sources for the same activity is consistent (e.g., identical). This is illustrated by a decision box 902. For example, collector/server 104 may be configured to determine whether the label, material, equipment used for the same activity as reported by client devices 102a and 102b match. In the event collector/server 104 determines the activity information from the two sources is consistent, collector/server 104 may store the activity information. In the event collector/server 104 determines there is consistency between the activity information from two sources, collector/server 104 may be configured to generate and transmit a request to one or both of client devices 102a and 102b. The request may instruct the respective client device(s) to verify the inconsistency, correct the inconsistency, re-provide the activity information, and/or perform any other actions.

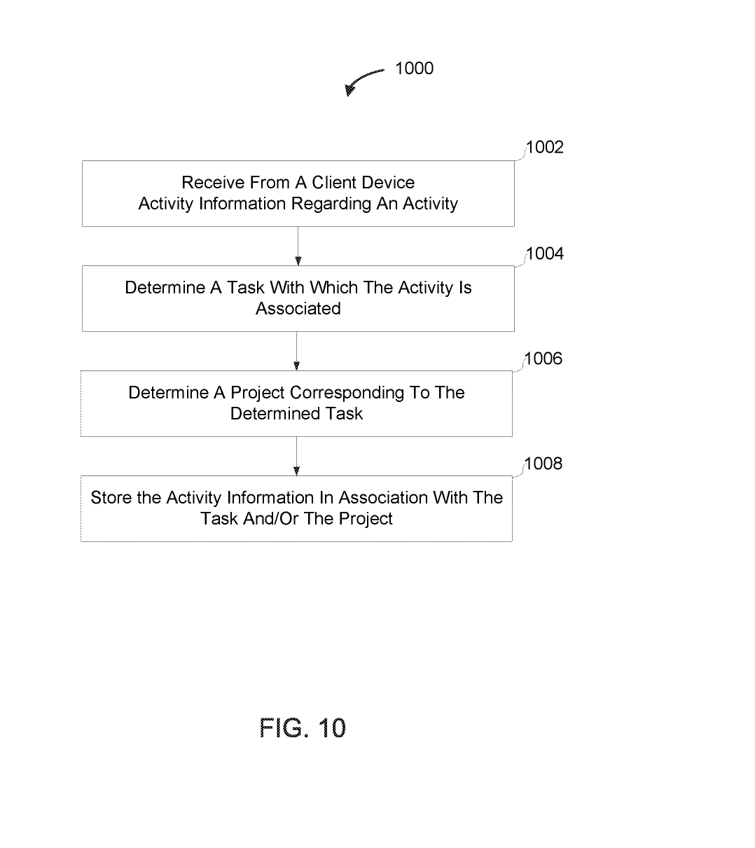

FIG. 10 illustrates a method 1000 for storing activity information in association with a task and/or a project, in accordance with one or more implementations. The operations of method 1000 presented below are intended to be illustrative. In some implementations, method 1000 may be accomplished with one or more additional operations not described, and/or without one or more of the operations discussed. Additionally, the order in which the operations of method 1000 are illustrated in FIG. 10 and described below is not intended to be limiting.

In some implementations, method 1000 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1000 in response to instructions stored electronically on an electronic storage medium. The one or more processing devices may include one or more devices configured through hardware, firmware, and/or software to be specifically designed for execution of one or more of the operations of method 1000.

At an operation 1002, activity information 302 regarding an activity may be received from client device 102. In some implementations, operation 1002 may be performed by a collector the same as or similar to collector 502 (shown in FIG. 5 and described herein).

At an operation 1004, a task associated with the activity for which activity information 302 is received at operation 1002 may be determined. In some implementations, activity information 302 received at operation 1002 may readily include task ID 306 indicating the activity is associated with a task identified by the task. In some implementations, activity information 302 received at operation 1002 may include activity ID 304 identifying the activity. In those implementations, operation 1004 may involve obtaining task IDs 306 that are associated with activity ID 304 from a relational database in accordance with the disclosure herein (e.g., the tables illustrated and described in FIG. 7). For example, without limitation, a relational table may be established in such a database to capture association between tasks and activities. In some implementations, operation 1004 may be performed by a project management component the same as or similar to project management component 522 (shown in FIG. 6 and described herein).

At an operation 1006, a project associated with the task(s) determined at operation 1004 may be determined. In some implementations, activity information 302 received at 1002 may readily include task ID 306 and project ID 308 indicating the activity is associated with the task scheduled in the project as identified by task ID 306 and project ID 308, respectively. In some implementations, activity information 302 received at operation 1002 may include activity ID 304 identifying the activity. In those implementations, operation 1006 may involve obtaining project ID(s) 308 that is associated with activity ID 304 via task ID 306 associated with both project ID(s) 308 and activity ID 304. For example, without limitation, relational tables may be established in a relational database to capture association among one or more of activities, tasks, and/or projects in accordance with the disclosure herein (e.g., the tables illustrated and described in FIG. 7). In some implementations, operation 1006 may be performed by a project management component the same as or similar to project management component 522 (shown in FIG. 6 and described herein).

At an operation 1008, activity information received at operation 1002 may be stored in association with task ID(s) 306 and/or project ID(s) 308 determined at operations 1004 and 1006, respectively. In some implementations, operation 1008 may be performed by a project management component the same as or similar to project management component 522 (shown in FIG. 6 and described herein).

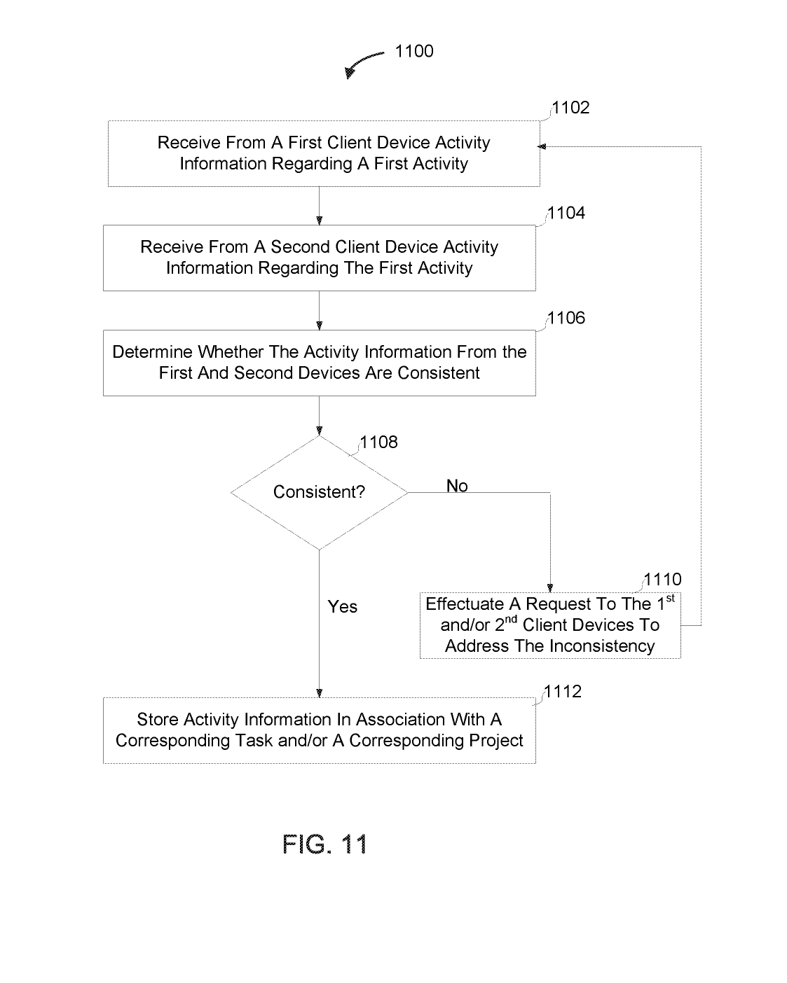

FIG. 11 illustrates a method 1100 for storing activity information in association with a task and/or a project, in accordance with one or more implementations. The operations of method 1100 presented below are intended to be illustrative. In some implementations, method 1100 may be accomplished with one or more additional operations not described, and/or without one or more of the operations discussed. Additionally, the order in which the operations of method 1100 are illustrated in FIG. 11 and described below is not intended to be limiting.

In some implementations, method 1100 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1100 in response to instructions stored electronically on an electronic storage medium. The one or more processing devices may include one or more devices configured through hardware, firmware, and/or software to be specifically designed for execution of one or more of the operations of method 1100.

At an operation 1102, activity information regarding a first activity may be received from first client device 102. In some implementations, operation 1102 may be performed by a collector the same as or similar to the collector 502 (shown in FIG. 5 and described herein).

At an operation 1104, activity information regarding the first activity may be received from second client device 102. In some implementations, operation 1104 may be performed by a collector the same as or similar to collector 502 (shown in FIG. 6 and described herein).

At an operation 1106, it may be determined whether there is inconsistency between activity information 302 received at operations 1102 and 1104. For example, operation 1106 determines whether one or more of the label, material, and/or equipment used for the first activity as indicated by activity information 302 received from first and second client devices 102 match. In some implementations, operation 1106 may be performed by a project management component the same as or similar to project management component 522 (shown in FIG. 6 and described herein).

At a decision 1108, a determination whether the activity information received at operations 1102 and 1104 is consistent is made. As shown, in the case where it is determined the activity information received at operations 1102 and 1104 is inconsistent, method 1100 proceeds to an operation 1110; and in the case where it is determined the activity information received at operations 1102 and 1104 is consistent, the method proceeds to an operation 1112.

At operation 1110, a request may be effectuated to request the first and/or the second client devices 102 to address the inconsistency determined at operation 1108. For example, the request effectuated at operation 1110 may instruct respective client devices 102 to perform one of more of verifying the inconsistency, correcting the inconsistency, re-providing activity information 302, and/or perform any other action. In some implementations, operation 1110 may be performed by a project management component the same as or similar to project management component 522 (shown in FIG. 6 and described herein).

At operation 1112, the activity information received at one or both of operation 1102 and/or 1104 may be stored in association with one or both of a corresponding task and/or a corresponding project. In some implementations, operation 1112 may be performed by a project management component the same as or similar to project management component 522 (shown in FIG. 6 and described herein).

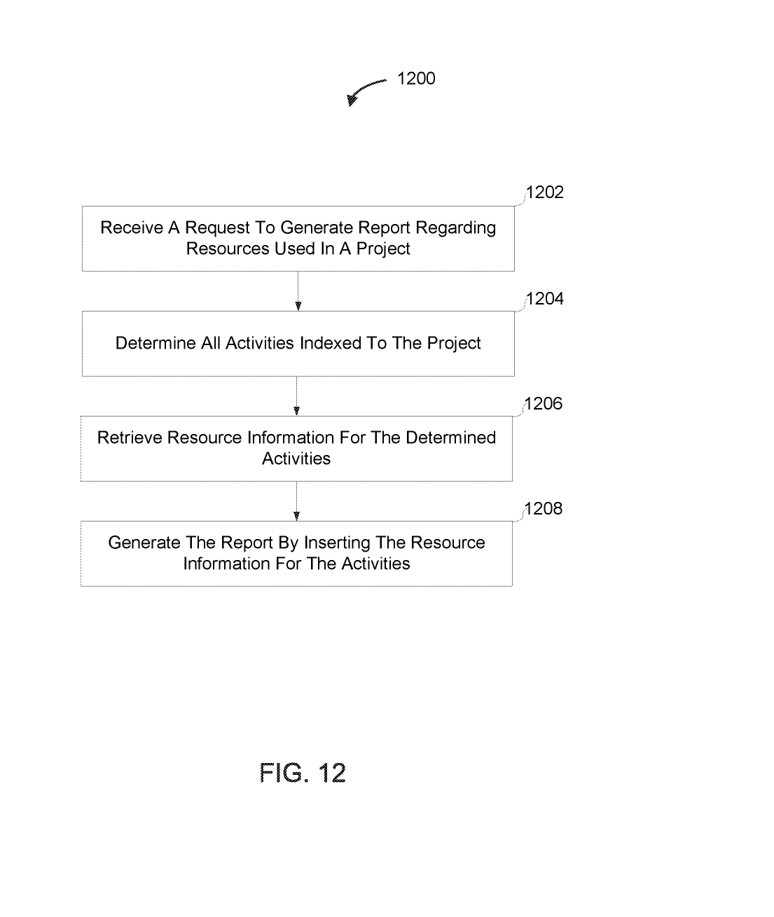

FIG. 12 illustrates a method 1200 for generating a report regarding a project, in accordance with one or more implementations. The operations of method 1200 presented below are intended to be illustrative. In some implementations, method 1200 may be accomplished with one or more additional operations not described, and/or without one or more of the operations discussed. Additionally, the order in which the operations of method 1200 are illustrated in FIG. 12 and described below is not intended to be limiting.

In some implementations, method 1200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1200 in response to instructions stored electronically on an electronic storage medium. The one or more processing devices may include one or more devices configured through hardware, firmware, and/or software to be specifically designed for execution of one or more of the operations of method 1200.

At an operation 1202, a request to generate a report regarding resources used in a project may be received. In some implementations, operation 1202 may be performed by a project management component the same as or similar to project management component 522 (shown in FIG. 6 and described herein).

At an operation 1204, activities indexed to the project for which the request is received at operation 1202 may be determined. For example, the activities may be determined by inquiring a relational database in which information regarding the activities is stored in association with the project by tasks. In some implementations, operation 1204 may be performed by a project management component the same as or similar to project management component 522 (shown in FIG. 6 and described herein).

At an operation 1206, relevant resource information may be retrieved for the activities determined at operation 1204. For example, operation 1206 may retrieve resource information for the activities that are associated with task IDs 306 associated with project ID 308 identifying the project. In some implementations, operation 1206 may be performed project management component same as or similar to project management component 522 (shown in FIG. 1 and described herein).

At an operation 1208, a report may be generated by inserting the resource information retrieved at operation 1206 into the report. In some implementations, operation 1208 may be performed project management component same as or similar to project management component 522 (shown in FIG. 6 and described herein).

It is to be understood that the aspects described herein can be implemented by hardware, software, firmware, middleware, microcode, or any combination thereof. When the systems and/or methods are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more aspects. It is, of course, not possible to describe every conceivable combination of components or methodologies for purposes of describing the aforementioned aspects, but one of ordinary skill in the art can recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.”

It should be appreciated that references throughout this specification to “one implementation” or “an implementation” means that a particular feature, structure or characteristic described in connection with the implementation is included in at least one implementation of the present invention. Therefore, it is emphasized and should be appreciated that two or more references to “an implementation” or “one implementation” or “an alternative implementation” in various portions of this specification are not necessarily all referring to the same implementation. Furthermore, the particular features, structures or characteristics may be combined as suitable in one or more implementations of the invention. In addition, while the invention has been described in terms of several implementations, those skilled in the art will recognize that the invention is not limited to the implementations described. The implementations of the invention can be practiced with modification and alteration within the scope of the appended claims. The specification and the drawings are thus to be regarded as illustrative instead of limiting on the invention.

What is claimed is:

1. A system configured to facilitate indexing activity information to a corresponding project, the system comprising:
one or more hardware processors configured by machine-readable instructions to:
receive from a client device activity information regarding an activity, the activity information including an activity identification identifying the activity;
determine, based on the activity identification, a task is associated with the activity;
determine a project is associated with the determined task; and
store the activity information in association with the task and/or the project.

2. The system of claim 1, wherein the task includes a task identification identifying the task.

3. The system of claim 1, wherein the activity information includes a description of the activity.

4. The system of claim 1, wherein the activity information includes a location of the activity.

5. The system of claim 1, wherein the activity information includes on or more participants of the activity.

6. The system of claim 1, wherein the activity information includes information regarding resources used or engaged during the activity.

7. The system of claim 1, wherein a task identification identifying the task is used to link activity to a project.

8. The system of claim 7, wherein the project comprises the task identified by a task identification.

9. The system of claim 8, wherein the task identification is predetermined on a client device as being associated with the project.

10. The system of claim 1, wherein the activity information is transmitted to a server over a communications network for storage and processing.

11. A method for facilitating indexing activity information to a corresponding project, the method being performed by one or more hardware processors configured by machine-readable instructions, the method comprising:
receiving from a client device activity information regarding an activity, the activity information including an activity identification identifying the activity;
determining, based on the activity identification, a task is associated with the activity;
determining a project is associated with the determined task; and
storing the activity information in association with the task and/or the project.

12. The method of claim 11, wherein the task includes a task identification identifying the task.

13. The method of claim 11, wherein the activity information includes a description of the activity.

14. The method of claim 11, wherein the activity information includes a location of the activity.

15. The method of claim 11, wherein the activity information includes on or more participants of the activity.

16. The method of claim 11, wherein the activity information includes information regarding resources used or engaged during the activity.

17. The method of claim 11, wherein a task identification identifying the task is used to link activity to a project.

18. The method of claim 17, wherein the project comprises the task identified by a task identification.

19. The method of claim 18, wherein the task identification is predetermined on a client device as being associated with the project.

20. The method of claim 11, wherein the activity information is transmitted to a server over a communications network for storage and processing.
